(19) United States
(12) Patent Application Publication
(10) Pub. No.: US 2014/0029051 A1
(43) Pub. Date: Jan. 30, 2014

(54) DEVICE CONTROLLING APPARATUS, DEVICE APPARATUS, AND CONTROL PROGRAM

(71) Applicant: SEIKO EPSON CORPORATION, Tokyo (JP)

(72) Inventor: Naruhide KITADA, Shiojiri (JP)

(73) Assignee: SEIKO EPSON CORPORATION, Tokyo (JP)

(21) Appl. No.: 13/948,234

(22) Filed: Jul. 23, 2013

(30) Foreign Application Priority Data
Jul. 24, 2012 (JP) 2012-163403

(51) Int. Cl. G06F 3/12

(52) U.S. Cl. CPC G06F 3/1287
USPC 358/1.15

(57) ABSTRACT

An information terminal has a Web browser that has a function to browse information. The Web browser includes a device search module for searching a printer connected to a network, a program acquiring module for acquiring a service script from the printer to control operations of the printer that was searched, and a program executing module for controlling operations of the printer by executing the service script that was acquired.

### CROSS-REFERENCE TO RELATED APPLICATIONS

This application claims priority to Japanese Patent Application No. 2012-163403 filed on Jul. 24, 2012. The entire disclosure of Japanese Patent Application No. 2012-163403 is hereby incorporated herein by reference.

### BACKGROUND

1. Technical Field

The present invention relates to a device controlling apparatus, a device apparatus, and a control program.

2. Related Art

In recent years, information terminals such as smartphones, tablet terminals, or the like are widely used. Suppliers of the service devices such as printers, scanners, or the like provide a service as, for example, a cloud service compatible with the information terminals so as to enable to control print operations and image scanning from the information terminals. A user can perform image printing or scanning from the information terminals by using the provided services.

As these services, for example, in Japanese Laid-Open Patent Application No. 2011-065655, an image processing device that receives a print command from a Web browser installed in the various information terminals was proposed.

### SUMMARY

In the image processing device disclosed in the above mentioned publication, an image data that is content for printing was generated and stored in the image processing device, and information related to the stored print data was sent to the Web browser of a client. However, to select the print data for a print target and to command printing on the Web browser by a user, various functions were required to be equipped in the image processing device so that it had problems that the image processing device and the user's operations became complicated.

The present invention is to resolve at least part of the above problems and enables to realize embodiments or applicable examples below.

In one aspect of the present invention, a device controlling apparatus includes a Web browser. In the device controlling apparatus that controls devices connected through a network in accordance with operations to the Web browser, the Web browser includes a device search module for searching devices connected to the network, a program acquiring module for acquiring programs from the devices so as to control the devices that were searched, and a program executing module for controlling the devices by executing the programs that were acquired.

Because of these configurations, the Web browser searches devices, which were connected to the network, and acquires programs for executing from the devices that were searched. Therefore, it is not necessary that the programs are executed on the device side so that the configuration of the devices can be simplified. In addition to that, the operability of the user is improved because the programs are executed in the device controlling apparatus.

### BRIEF DESCRIPTION OF THE DRAWINGS

Referring now to the attached drawings which form a part of this original disclosure:

FIG. 1 is an illustration describing an information terminal as a device controlling apparatus according to an embodiment.

FIG. 2 is a flowchart describing a flow of a printing process in an information terminal.

FIG. 3 is an illustration showing a display example of printer search buttons.

FIG. 4 is an illustration showing a display example of a printer selecting module.

### DETAILED DESCRIPTION OF EXEMPLARY EMBODIMENTS

Hereinafter, the embodiment of the present invention will be described in reference to the drawings.

### Embodiment

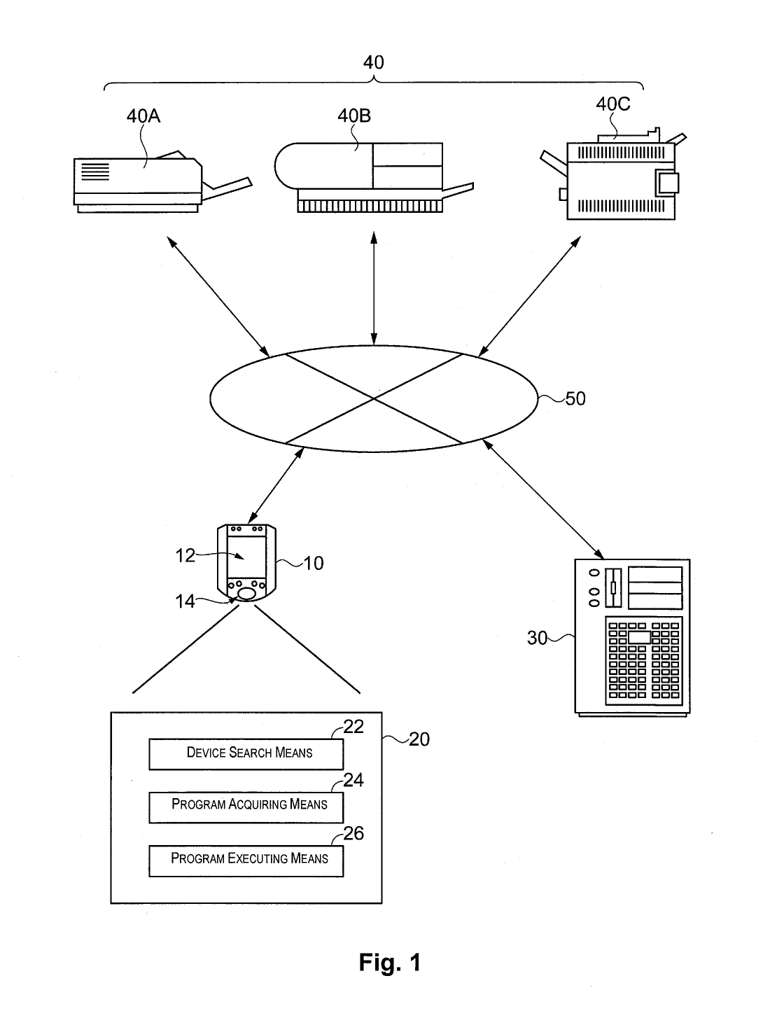

FIG. 1 is an illustration describing an information terminal 10 as a device controlling apparatus according to the present embodiment. In the present embodiment, a printer 40 is anticipated as a target device to be controlled. Also, a computer having portability such as tablet terminals or smartphones is anticipated as the information terminal 10. This information terminal 10 has CPU, RAM, ROM, and the like as hardware, and various operations are controlled by an operating system (OS). Also, in the information terminal 10, a display part 12 and a controller 14 are provided. A user controls the controller 14 based on information displayed in the display 12 so that the user can instruct a desired operation to the information terminal 10.

The information terminal 10 also has a connection to be able to communicate with a printer 40 or a Web server 30 through a network such as an internet, an intranet, or the like.

In the present embodiment, a printer 40 is anticipated as three printers (40A, 40B, 40C) having different printing methods, installation locations, and the like. These printers have functions of generating print data that is printable in a print engine in accordance with a specification its own, retaining programs (service scripts) to perform the processes in the information terminal 10 so as to control the printer 40, and transmitting the data of service scripts in response to a transmission request from the information terminal 10 as a connecting destination. In addition to the printing functions, the printer 40 is also anticipated as a multi-functional device having an image scanning function or a copy function.

Further, the Web server 30 is a computer that provides displaying a HTML file, an image file, or the like written in HTML, which is one of the markup languages, on the Web browser 20 of the information terminal 10 in accordance with HTTP, which is one of communication protocols.

The Web browser (browser means) 20 provided with the information terminal 10 has functions to acquire a HTML file, an image file, or the like, which is provided from the Web server 30, and to analyze layout and display it for a user in a readable form. Furthermore, the Web browser 20 has a device search module 22, a program acquiring module 24, and a program executing module 26.

The device search module 22 has a function to search a device (hereinafter referred to as “service device”) as the printer 40 connected to the network 50. Further, the device search module 22 may add a search condition of a service device as a search target when it searches a service device.

Possible examples of the search conditions include: being a print resolution at 200 dpi; enabling to perform a color printing; having a function to read an optical character; and enabling to print on an A4 size paper. Such search conditions in response to the contents displayed in the Web browser 20 or such search conditions that a user desires may be added. Also, the search conditions may be determined by an authority of a user so that it is limited to perform a black-and-white printing for a general public user.

In the present embodiment, the search for a service device is performed by using UPnP (registered trademark) which is a specification to provide functions reciprocally within the network 50.

As the search result, the information terminal 10 can obtain a response from the service device with attribute information of a model name, a unique name given by an administrator, an icon data that indicates the service device, and the like related to the service device that was searched.

The program acquiring module 24 has functions to request a service script to the selected service device among the service devices that were obtained by the search, and to retain the data of service script sent from the destination of the service device. In the present embodiment, the service script has the same function as a printer driver installed in a client computer, and it is written in Lua language, JavaScript (registered trademark) language, or the like. An aspect of the service script that can be independently executed to the OS is anticipated, but it is not limited to this aspect.

Further, the program acquiring module 24 determines a target function to be used among the functions provided in the service device selected from the obtained service devices that were searched. In response to the function that was determined, the program that limits the function to be realized by controlling the service device may be obtained from the service device.

Moreover, the program acquiring module 24 acquires a program, which is used to obtain the device information of the information terminal 10 and to transmit the information to a service device, from the service device that was searched and executes the program. A program that changes a function to be realized in response to the device information that was sent may be acquired.

The program executing module 26 has a function to be executed by spreading the data of retained service script to the predetermined memory space. The data of service script after executing may be deleted from the memory space after a predetermined period of time was elapsed, or it may be stored in a flash memory, and the like of the information terminal 10.

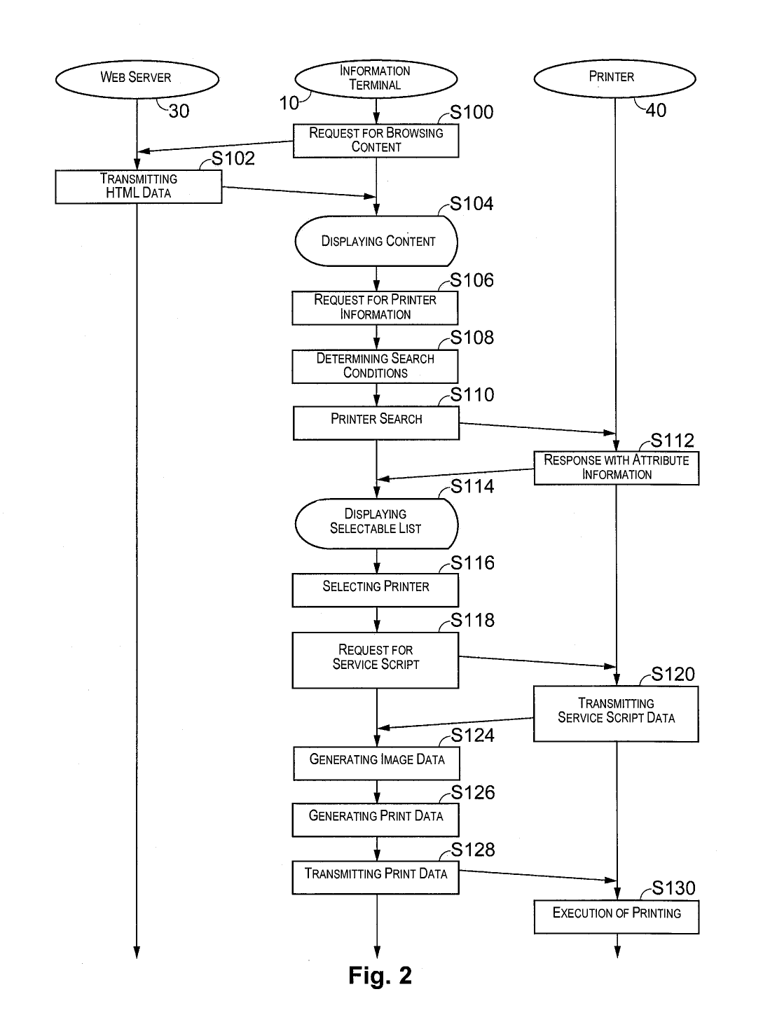

FIG. 2 is a flowchart describing a flow of printing process in the information terminal 10.

When the process of FIG. 2 starts, the information terminal 10 requests to access for browsing the desired content to the Web server 30 based on the operations of a user (Step S100).

The Web server 30 receives a content browsing request from the information terminal 10 and transmits HTML data in response to the requested content to the information terminal 10 (Step S102).

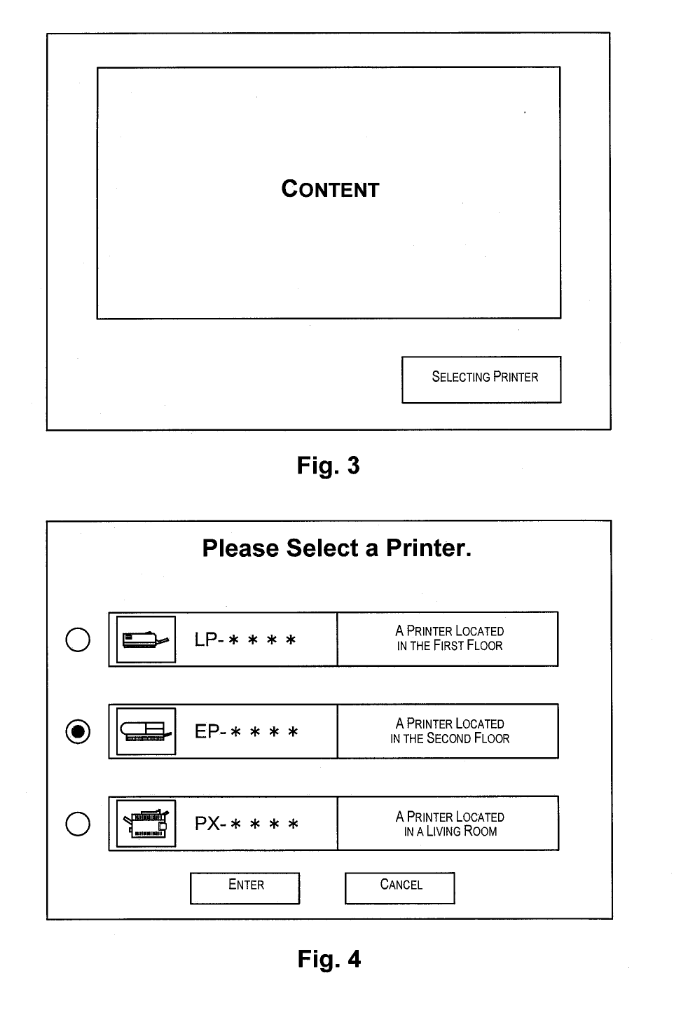

The information terminal 10 receives the HTML data transmitted from the Web server 30, and an image based on the HTML data is generated to display in the display part 12 (Step S104). Here, FIG. 3 shows a display example in the display part 12. In the display example, the Web browser 20 shows an image of the content, and a button “selecting a printer” is shown in a predetermined position so that it is selectable. When a user prints the image of the content, first, the button “selecting a printer” is pressed and the information of the printer connected to the network 50 is requested.

Returning to FIG. 2, the printer information request process is executed by the operations of the user to the information terminal 10 (Step S106). First, the Web browser 20 analyzes the HTML data of the content, and the search conditions are determined in a case of searching the printers 40 (Step S108).

Next, the Web browser 20 transmits a search signal to the network 50, and a printer search that meets the determined search conditions is performed (Step S110).

The printers 40 receive the search signal, and when the search conditions are met, a response including own attribute information is sent back to the information terminal 10 (Step S112).

The information terminal 10 shows information of the printers 40, which are selectable by a user, in the display part 12 based on the response transmitted from the printers 40, and displays the selecting module to select a printer 40 by the user (Step S114). Here, FIG. 4 shows a display example in the display part 12. In the display example, the Web browser 20 shows icons of selectable printers (40A, 40B, 40C), names, and unique printer's names.

The information of the printers 40 obtained in the previous search was stored, and when it searches the printers 40 and the screen of FIG. 4 is displayed, the Web browser 20 may preferentially check whether or not the printers 40 that were previously searched are connected. Further, when a plurality of printers 40 were searched, the printers 40 that were previously selected maybe displayed as a default printing destination candidate.

The user selects a printing destination among these printers (40A, 40B, 40C), and the user can direct the execution of the printing to the selected destination. Hereafter, in order to facilitate the understanding of the description, it is anticipated that the user has selected the printer 40B.

Returning to FIG. 2, the printer 40B for the printing destination is selected by the user on the Web browser 20 (Step S116). Next, the information terminal 10 requests a service script to the selected printer 40B (Step S118).

The printer 40B requested for the service script transmits the data of own retained service script to the information terminal 10 (Step S120).

The information terminal 10 receives the data of service script and executes the received service script. The information terminal 10 also performs rendering processing to the HTML data of the content displayed in the Web browser 20 and generates the image data (Step S124). Further, the print data is generated from the generated image data (Step S126).

Next, the information terminal 10 transmits the generated print data to the printer 40B as a print target (Step S128). In this case, prior to transmitting the print data to the printer 40B, the user checks the print image based on the print data in the display 12 of the information terminal 10, and it may be transmitted based on the result of the confirmation.

The printer 40B receives the print data and performs printing based on the received print data (Step S130). The print process is end.

According to the above described embodiment, the following effects are achieved.

(1) The printers 40 retain service scripts to generate print data and to execute printing in the printers 40. The printers 40 transmit it to the information terminal 10 in response to a print request from the information terminal 10 and generate the print data on the information terminal 10 side. Accordingly, it is not necessary to have various image processing functions on the printer 40 side and the configurations can be simplified.

(2) Prior to executing the printing, the information terminal 10 receives service scripts from the printers 40, and the service scripts are corresponding to the printers 40. Therefore, it is not necessary that the information terminal 10 preliminarily have various service scripts corresponding to varieties of the printers 40, and the resources of the information terminal 10 can be reduced.

(3) The service scripts to generate the print data are executed on the Web browser 20 so that it does not rely on the OS of the information terminal 10. Therefore, the time and effort to produce a different service script depending on a type of the OS and its costs can be reduced.

The embodiment of the present invention was described in reference to the drawings, but the specific configurations are not limited to this embodiment so that it will include that the modifications of design can be made within the scope without substantially departing from the present invention. For example, as the functions provided by the service device, a scanner function may be anticipated other than the print function. Further, an embodiment adding services to develop the scanning function such as an optical character reader (OCR) function, a time certification process function, and the like may be provided by using OAuth technology, and the like.

In addition, in a case of the scanning function, the scan data may be sent to the Web browser 20, or the scan data may be sent to another cloud service as a data storage destination.

Moreover, a device executing the above means may be realized as a single device, or combining a plurality of devices so that various embodiments may be included.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A device controlling apparatus comprising:
a Web browser for browsing information so that the device controlling apparatus controls a device connected through a network based on operations to the Web browser,
wherein the Web browser includes
a device search module for searching the device connected to the network,
a program acquiring module for acquiring program from the device to control the device that was searched, and
a program executing module for controlling the device by executing the acquired program.

2. The device controlling apparatus according to claim 1, wherein
the device search module determines a search condition for searching the device and searches the device that meets the determined search condition.

3. The device controlling apparatus according to claim 1, wherein
the program acquiring module determines a target function for use among functions provided in the device that was searched, and acquires the program, which limits a function to be realized by controlling the device in response to the determined function, from the device.

4. The device controlling apparatus according to claim 1, wherein
the program acquiring module acquires and executes a program to transmit device information of the device controlling apparatus from the device that was searched, and acquires the program changing a function to be realized in response to the device information that was transmitted.

5. The device controlling apparatus according to claim 1, wherein
the Web browser displays information related to a plurality of devices that the device search module searched, and
the device controlling apparatus further includes a selecting module for selecting the device as an acquisition destination of the program from the plurality of devices that were displayed.

6. The device controlling apparatus according to claim 1, wherein
the program executing module generates control data to control the device by executing the program, and the control data is sent to the device.

7. A device apparatus that is connected to a device controlling apparatus provided with a Web browser through a network, wherein the Web browser includes a function for browsing information, the device apparatus comprising:
a retaining module for retaining program which is executable by the Web browser to control a device;
a transmitting module for transmitting the program to the device controlling device when a request to send the program is received from the device controlling apparatus; and
a processing module for performing process in accordance with control from the program executed in the device controlling device.

8. A non-transitory computer readable medium that stores a control program to control a device connected through a network, the device being controlled based on operations of a Web browser for browsing information, the control program executed in a computer comprising:
a device searching function that searches the device connected to the network;
a program acquiring function that acquires program from the device so as to control the device that was searched; and
a program executing function that controls the device by executing the program that was acquired.
